(19) United States
(12) Patent Application Publication
(10) Pub. No.: US 2009/0031925 A1
(43) Pub. Date: Feb. 5, 2009

(54) Gas-Forming Agent For Cement Composition

(76) Inventors: Takao Furusawa, Kanagawa (JP); Takashi Ishii, Yokohama-shi (JP); Takeo Ozawa, Kanagawa (JP)

Correspondence Address: CURATOLO SIDOTI CO., LPA, 24500 CENTER RIDGE ROAD, SUITE 280, CLEVELAND, OH, 44145, US

(21) Appl. No.: 11/922,369

(22) PCT Filed: Jun. 6, 2006
(86) PCT No.: PCT/EP2006/005354

§ 371 Date: Mar. 12, 2008

(30) Foreign Application Priority Data
Jun. 24, 2005 (JP) 2005-185607

(51) Int. Cl. C04B 38/02; C04B 24/12

(52) U.S. Cl. 106/678; 106/820; 106/672; 106/677

(57) ABSTRACT

[Problem to be Solved] To provide a gas-forming agent which exhibits no hydrogen embrittlement and allows gas generation to achieve a desired amount of inflation even in the presence of nitrite, and a cement composition utilizing the agent which offers improved shrinkage compensation.

[Solution] The gas-forming agent for a cement composition containing nitrite comprises a substance which produces nitrogen gas through a reaction in the cement composition.

### TECHNICAL FIELD

The present invention relates to: a gas-forming agent for a cement composition, the gas forming agent having an excellent gas-forming property and being suitable for use in cement compositions containing nitrite in the field of civil engineering, architecture, and others; a cement composition containing nitrite and added with the gas forming agent; a method of preventing the shrinkage of a cement composition using the gas-forming agent; and the use of the gas-forming agent for a cement composition containing nitrite.

### BACKGROUND ARTS

Conventionally, cement compositions such as concrete, mortar, and grout material have been used in installing machinery, constructing joints for inversely placed concrete, repairing deteriorated part of concrete, and filling the PC duct of pre-stressed concrete structures. So far, various filling materials have been developed, among which hydraulic cement compositions are most widely used, and their composition is based on cement alone or the combination of cement and fine aggregates (further including coarse aggregates if necessary) and added with various additives depending on applications. Generally, when a hydraulic cement composition based on cement alone or the combination of cement and fine aggregates (further including coarse aggregates if necessary) is deposited after mixing with water, shrinkage or settlement may occur during setting, thereby causing an air-gap layer between a previously cast part and newly filled material, or settlement or cracks of the filled material.

Under those circumstances, in order to prevent shrinkage, aluminum powder or carbonaceous materials have been utilized as an additive. Aluminum powder reacts with alkali, which is produced through the reaction of cement and water, to generate hydrogen gas during the period from the moment when the hydraulic cement composition is flowable until the moment of its setting and thereby causes the hydraulic cement composition to expand compensating for its shrinkage. When carbonaceous material is added to a cement composition, it absorbs water from the mixture because of its porous nature, and releases the gas entrapped in the pours to cause the cement composition to expand thereby compensating for its shrinkage.

For example, a PC grout material is cast around a PC steel bar of a PC (pre-stressed concrete) structure after tensioning the PC steel bar for the purpose of protecting the PC steel bar from corrosion and integrating the PC steel bar and the structural concrete. When a PC grout material is added with aluminum powder, alkali in the cement and the aluminum powder react to generate hydrogen gas; and therefore, there is a concern that the hydrogen gas would cause hydrogen embrittlement of the PC steel bar.

Further, in recent years, deterioration of concrete due to chloride attack has become an issue and, as a countermeasure against it, a repair work is commonly practiced in which deteriorated part of concrete is removed for repair using an air pick, an electric pick, a water jet, etc. and thereafter the part to be repaired is refilled with cement mortar or polymer cement mortar. In this execution method, in order to prevent re-deterioration of the repaired part due to chloride attack, nitrite is added to the mortar for refilling. On the other hand, the mortar used in such circumstances contains aluminum powder to compensate for early stage shrinkage before curing, which causes a problem that mixing mortar containing nitrite with aluminum powder would not produce expected amount of expansion or no expansion at all. Although the reason of this is not clear, it is inferred that nitrite would hinder the reaction between aluminum powder and alkali.

Besides the above described method of using an additive for producing hydrogen gas, such as aluminum powder, a method of using organic additives such as methyl ethyl ketone peroxide, azodicarbonamide, sodium azodicarboxylate, and p-toluenesulfonyl hydrazide to produce oxygen or nitrogen gas thereby compensating for the shrinkage of the cement composition has been reported (see patent document 1). However, this method has not being applied to cement compositions containing nitrite, and there is no description at all about the effectiveness of the above described organic additives in the presence of nitrite.

[Patent document 1] U.S. Pat. No. 4,142,909.

### DISCLOSURE OF THE INVENTION

### Problem to be Solved by the Invention

Accordingly, it is an object of the present invention to provide a gas-forming agent which can generate a sufficient amount of gas to produce desired expansion even in the presence of nitrite and which does not cause hydrogen embrittlement, and a cement composition which utilizes the aforementioned gas-forming agent and provides a good shrinkage compensation.

### Means for Solving the Problem

The present inventors have diligently conducted an investigation to solve the above described problem and have found that mixing a cement composition containing nitrite with a substance which generates nitrogen gas through a reaction in the foregoing composition allows effective generation of nitrogen gas even in a cement composition containing nitrite thereby successfully compensating for the shrinkage of the cement composition.

Accordingly, the present invention relates to a gas-forming agent for a cement composition containing nitrite, the gas-forming agent comprising a substance which produces nitrogen gas through a reaction in the cement composition.

Further, the present invention relates to the above-described gas-forming agent, wherein the substance which produces nitrogen gas through a reaction in a cement composition includes at least one compound selected from the group consisting of sulfonyl hydrazide compounds, azo compounds, and nitroso compounds.

The present invention further relates to a cement composition containing nitrite, the cement composition comprising the above-described gas-forming agents.

The present invention also relates to the above described cement composition, wherein the cement composition is a grout material, a PC grout material, a mortar material, or a concrete material.

The present invention also relates to the above described cement composition, further comprising a water-reducing agent.

The present invention also relates to the above described cement composition, further comprising an inflating agent.

The present invention also relates to a method for preventing shrinkage of a cement composition containing nitrite, the method comprising mixing the above-described gas-forming agent into the cement composition.

The present invention further relates to the above described method for preventing shrinkage, wherein the cement composition is a grout material, a PC grout material, a mortar material, or a concrete material.

The present invention further relates to the above-described method for preventing shrinkage, the method comprising further adding a water-reducing agent.

The present invention further relates to the above described method for preventing shrinkage, the method comprising compensating for the shrinkage of the cement composition before curing by means of the above described gas-forming agent, and compensating for the shrinkage of the cement composition after curing by means of an inflating agent.

The present invention further relates to use of the above-described gas-forming agent in a cement composition containing nitrite.

The present invention further relates to the above described use, wherein the cement composition is a grout material, a PC grout material, a mortar material or a concrete material.

The present invention further relates to the above described use, wherein said cement composition further contains a water-reducing agent.

The present invention further relates to the above described use, wherein said cement composition further contains an inflating agent.

The present invention is based on the founding that when aluminum powder is used as the gas-forming agent, gas forming in a cement composition is hindered by nitrite resulting in insufficient shrinkage compensation effect, while when a compound which produces nitrogen, such as sulfonyl hydrazide compounds, azo compounds, and nitroso compounds is used, gas forming will not be hindered even in the presence of nitrite thereby achieving a sufficient shrinkage compensating effect for a cement composition.

The gas-forming agent of the present invention can be used along with a water-reducing agent as described above. The water-reducing agent has an effect that anionic water-reducing component adsorbs onto cement particles thereby dispersing the cement particles, increasing the flowability of the cement composition, and reducing the water content. The cement composition containing the gas-forming agent of the present invention and water-reducing agent not only has an effect of compensating for shrinkage by a gas-forming agent and an effect of increasing the flowability by means of a water-reducing agent, but also has an effect of reducing the bleeding rate of the cement composition. The water-reducing agent includes naphthalenesulfonic acid-based, melamine-based, polycarboxylate-based, lignin sulfonate-based, and other agents which are commercially available as a water-reducing agent, an AE water-reducing agent, a high-range water-reducing agent, and a high-range AE water-reducing agent.

Further, the gas-forming agent of the present invention may also be used along with an inflating agent. Since the inflating agent has an effect of compensating for the shrinkage of a cement composition due to hydration or drying after curing, it is made possible to compensate for the shrinkage of a cement composition throughout its period of service by compensating for the shrinkage in the early stage before the curing of the cement composition by means of the gas-forming agent and by compensating for the shrinkage of the cement composition after curing by means of the inflating agent. The inflating agent for concrete includes commercially available calcareous or CSA-based inflating agents specified by JIS A 6201, calcium oxide powder, or agents with an increased degree of fineness obtained by crushing the aforementioned inflating agents.

Not only the gas-forming agent of the present invention will not be hindered by nitrite from gas forming, but also it will not pose any risk of causing hydrogen embrittlement of the steel member since it produces nitrogen gas through gas forming unlike a conventional gas-forming agent such as aluminum powder and iron powder which produces hydrogen gas through gas forming. Further, besides the above described repair work of concrete suffering chloride attack, nitrite is being used for accelerating the setting of a cement composition, anti-freezing purposes, and others; therefore, the gas-forming agent of the present invention will be effective for cement compositions containing nitrite for all kinds of uses.

### ADVANTAGES OF THE INVENTION

The gas-forming agent of the present invention produces nitrogen gas through a reaction in a cement composition containing nitrite and thus causes the cement composition to expand making it possible to obtain a shrinkage-free cement composition. Further, since the gas-forming agent of the present invention enables an accurate control of the expansion rate of a cement composition by varying its usage amount, it is made possible to obtain a shrinkage-free, uniform cement composition.

### THE BEST MODE FOR CARRYING OUT THE INVENTION

The gas-forming agent of the present invention may by achieved by adding a compound which produces nitrogen gas through a reaction in a cement composition, such as, for example, a compound which produces nitrogen gas through the reaction with alkali which is produced when the cement component contained in the cement composition is mixed with water. The compound which produces nitrogen gas includes sulfonyl hydrazide compounds, azo compounds, and nitroso compounds. More specifically, the sulfonyl hydrazide compounds include p-toluenesulfonyl hydrazide, p,p′-oxybis(benzene sulfonyl hydrazide), 4,4′-oxybis(benzene sulfonyl hydrazide), and others; the azo compounds include azodicarbonamide, azobisisobutyronitrile, and others; and the nitroso compounds include N,N′-dinitrosopentamethylenetetramine and others. Particularly, sulfonyl hydrazide compounds such as p-toluenesulfonyl hydrazide, p,p′-oxybis(benzene sulfonyl hydrazide), 4,4′-oxybis(benzene sulfonyl hydrazide), and others are suitable for cement compositions since their reaction products are odor less, non-pollutant, and color less. The gas-forming agent of the present invention preferably contains at least one of the aforementioned compounds.

Provided that the above described substances for generating nitrogen gas actually produce nitrogen gas in the most part through a reaction, it may produce gases other than nitrogen gas as a byproduct such as carbon monoxide, carbon dioxide, and ammonia gasses. For example, azo compounds produce ammonia other than nitrogen as a reaction product. Moreover, since N,N′-dinitrosopentamethylenetetramine is flammable, it must be handled with care.

The cement composition of the present invention may be a composition composed of: cement such as various kinds of portland cement, mixed cement, echo-cement, and alumina cement; nitrite; and the gas-forming agent of the present invention Examples of the cement composition include cement paste, mortar, concrete, PC grout, grout materials, and others.

Nitrite added to the cement composition may be, but not limited to, lithium nitrite, sodium nitrite, calcium nitrite, potassium nitrite, barium nitrite, or others. The content of nitrite will vary depending on the uses and may typically be, but not limited to, about 0.5 to 10 parts with respect to 100 parts of cement.

Since the content of the gas-forming agent of the present invention will vary depending on the kind of the cement composition such as cement paste, mortar, and concrete, the kind of the gas-forming agent, the use thereof, and others, the content will not be limited to a particular value, but it may be an amount to obtain an expansion rate of 0.1% to 5% which is typically required for such cement compositions. Generally, the content is preferably about 0.01 to 1 parts by weight with respect to 100 parts by weight of cement.

The cement composition of the present invention may be mixed with components other than the above-described components such as aggregates and additives within arrange not to compromise the purpose of the present invention. The usable aggregate includes, but not limited to, river sand, mountain sand, silica sand, lime sand, general lightweight sand, river gravel, crushed stone, lime stone, general lightweight coarse aggregates, and others. When the cement composition is mortar, cement milk, or others, the use amount of aggregate is preferably 0 to 400 parts by weight with respect to 100 parts by weight of cement. And when the cement composition is concrete, the use amount of lightweight aggregate is preferably 100 to 400 parts by weight, and the use amount of coarse aggregate is preferably 100 to 400 parts by weight, respectively with respect to 100 parts by weight of cement.

The additive mentioned above includes inorganic fine powder, inflating agents for concrete, water-reducing agents, thickening agents, setting adjustors, polymers, etc. The inorganic fine powder includes blast furnace slag powder, blast furnace slag fine powder, fly ash, silica fume, calcium carbonate powder, stone dust, etc. The setting adjuster includes citric acid, tartaric acid, malic acid, gluconic acid, and alkali metal salts and/or alkaline-earth metal salts thereof such as oxycarbonic acids. The thickening agent includes, for example, methylcellulose, methylethylcellulose, hydroxyl propylcellulose, carboxymethylcellulose, guar gum, alginate, polyvinylalcohol, polyacrylic acid, and polyethylene oxide. The polymer includes powder polymer or polymer dispersion in which polymer is dispersed in water, such as vinylacetate basatate, polyacrylic ester, ethylene-vinyl acetate copolymer, styrene-acrylic ester copolymer, and acrylonitrile-acrylic ester copolymer.

The method of preventing the shrinkage of cement composition according to the present invention is characterized in that a cement composition containing nitrite is mixed with the gas-forming agent of the present invention. In the method of mixing the gas-forming agent, cement and part or all of the gas-forming agent may be pre-mixed, may be further mixed with other materials, or each material may be mixed upon execution. The reaction associated with the gas-forming agent does not require control in terms of temperature and normally may be carried out at room temperature.

The method for preventing shrinkage according to the present invention makes it possible to accurately adjust the expansion rate of a cement composition by varying the amount of gas-forming agent since the gas forming by the gas-forming agent will not be hindered by nitrite. Therefore, it is possible to obtain a uniform cement composition according to the method of the present invention.

Although the gas-forming agent of the present invention provides sufficient shrinkage compensation effect, other gas-forming agents (such as aluminum powder, iron powder, organic or inorganic peroxides, etc.) may be used in combination when necessary.

### EMBODIMENTS

Hereinafter, examples and comparative examples will be shown and described in detail, but the present invention will not be limited to such examples.

### Reference Example 1

### Grout Material Test I

Grout materials of compositions shown in Table 1 were prepared by using the following materials and were tested through test methods shown below. The results are shown in Table 1.

### Materials Used:

Cement: Ordinary portland cement,

Fine aggregate: Silica sand of a particle size not greater than 2.5 mm,

High-range water-reducing agent A: “Mighty 100” manufactured by Kao Corporation,

Gas-forming agent α: “NEOCELLBORN N#1000SW” (main ingredient: 4,4′-oxybis[benzene sulfonyl hydrazide]) manufactured by Eiwa Chemical Ind. Co., LTD., and

Mixing water: Service water.

Notes: W/C in the table represents (weight of service water/weight of cement)×100(%).

### Test Method:

All the materials were kneaded for 2 minutes after loading using a hand mixer of a rotational speed of 750 rpm. The resulting grout materials were subjected to the following tests.

i. J14 Funnel Flow-Time

Measurements were conducted according to the Japanese Society of Civil Engineering standard “Test Method of Flowability for Filling Mortar (JSCE-F 541-1999).”

ii. Bleeding Rate and Expansion Rate

Measurements were conducted according to the Japanese Society of Civil Engineering standard “Test Method of Bleeding Rate and Expansion Rate for Filling Mortar (Container Method) (JSCE-F 542-1999).” The bleeding rate was measured at the age of 3 hours, and the expansion rate was measured at the age of day. In the Table, negative values of the expansion rate indicate shrinkage and positive values indicate expansion.

TABLE 1

| | | Mortar content (parts by weight) | | | | | | | | |
|---|---|---|---|---|---|---|---|---|---|---|
| | | | | High-range | | | | | | |
| | | | | water-reducing | | | | J14 funnel | Bleeding | Expansion |
| Reference | W/C | | Fine | agent | | Gas-forming agent | | flow-time | rate | rate |
| example | (%) | Cement | aggregate | Type | Use amount | Kind | Use amount | (second) | (%) | (%) |
| 1-1 | 38 | 100 | 0 | A | 0.4 | None | — | 4.3 | 0.5 | −0.68 |
| 1-2 | 34 | | 100 | A | 0.7 | None | — | 7.4 | 0.7 | −0.90 |
| 1-3 | 43 | | 200 | A | 0.6 | None | — | 8.5 | 0.8 | −1.20 |
| 1-4 | 52 | | 300 | A | 0.5 | None | — | 8.6 | 1.1 | −1.40 |
| 1-5 | 60 | | 400 | A | 0.5 | None | — | 9.6 | 1.5 | −1.80 |
| 1-6 | 34 | | 0 | A | 0.4 | α | 0.2 | 4.5 | 0.2 | +0.65 |
| 1-7 | 34 | | 100 | A | 0.7 | α | 0.2 | 7.1 | 0.4 | +0.45 |
| 1-8 | 43 | | 200 | A | 0.6 | α | 0.2 | 8.7 | 0.4 | +0.54 |
| 1-9 | 52 | | 300 | A | 0.5 | α | 0.3 | 8.9 | 0.6 | +0.59 |
| 1-10 | 60 | | 400 | A | 0.5 | α | 0.4 | 9.8 | 0.8 | +0.61 |

As shown in Table 1, reference examples 1-1 to 1-5, to which no gas-forming agent was added, exhibited J14 funnel flow-times of 4.3 to 9.6 seconds indicating a good flowability as a grout material. However, since no bleeding inhibitor was used in this test, bleeding rates of 0.5% to 1.5% were observed. Also, reference examples 1-1 to 1-5 exhibited expansion rates of −0.68% to −1.8% indicating the occurrence of shrinkage. On the other hand, reference examples 1-6 to 1-10, in which the mixing ratio of cement and sand was varied from 100:100 to 100:400 and to which the gas-forming agent of the present invention and a high-range water-reducing agent were added, exhibited J14 funnel flow-times of 4.5 to 9.8 seconds also indicating a good flowability as a grout material. Likewise, bleeding rates of 0.2 to 0.8% were observed since no bleeding inhibitor was used in the test. Also, reference examples 1-6 to 1-10 exhibited expansion rates of +0.45 to +0.65% meaning that a shrinkage-free grout material was obtained. And the bleeding rate was lower in reference examples 1-6 to 1-10 than in reference examples 1-1 to 1-5 when comparing the ones of the same composition with or without the gas-forming agent.

### Reference Example 2

### Test of Grout Material II

Grout materials of the compositions shown in Table 2 were prepared by using the following materials, and were tested through the test method shown below. The results are shown in Table 3.

### Materials Used:

Cement: Ordinary portland cement

Fine aggregate: silica sand of a particle size not greater than 2.5 mm,

High-range water-reducing agent A: “Mighty 100 (naphthalene based)” manufactured by Kao Corporation,

High-range water-reducing agent B: “MELMENT F-10 (melamine based)” manufactured by Degussa AG,

High-range water-reducing agent c: “Melflux1641F (polycarboxylate base)” manufactured by Degussa Construction Systems Co., LTD,

Inflating agent a: “DENKA CSA#20” manufactured by DENKI KAGAKU KOGYO KK,

Inflating agent b: “EXSPAN G” manufactured by TAIHEIYOU CEMENT Corporation,

Gas-forming agent α: “NEOCELLBORN N#1000SW” (main ingredient: 4,4′-oxybis[benzene sulfonylhydrazide], wet type) manufactured by Eiwa Chemical Ind. Co., LTD,

Gas-forming agent β: VINYFOR AC#3 (main ingredient: azodicarbonamide) manufactured by Eiwa Chemical Ind. Co., LTD,

Gas-forming agent γ: “NEOCELLBORN” N#1000S (main ingredients: 4,4′-oxybis[benzene sulfonyl hydrazide]) manufactured by Eiwa Chemical Ind. Co., LTD, and Mixing water: Service water.

Notes: W/C in the table represents (weight of service water/weight of cement)×100(%)

### Test Method:

All the materials were kneaded for 2 minutes after loading using a hand mixer of a rotational speed of 750 rpm. The resulting grout materials were subjected to the following tests.

i. J14 Funnel Flow-Time

Measurements were conducted according to the Japanese Society of Civil Engineering standard “Test Method of Flowability for Filling Mortar (JSCE-F 541-1999).”

ii. Bleeding Rate and Expansion Rate

Measurements were conducted according to the Japanese Society of Civil Engineering standard “Test Method of Bleeding Rate and Expansion Rate for Filling Mortar (Container method) (JSCE-F 542-1999).” The bleeding rate was measured at the age of 3 hours, and the expansion rate was measured at the age of day. In the Table, negative values of the expansion rate indicate shrinkage and positive values indicate expansion.

iii. Compressive Strength

Compressive strength at the age of 28 days was measured according to the Japanese Society of Civil Engineering standard “Test Method of Compressive Strength for Filling Mortar (JSCE-G 541-1999).”

TABLE 2

| | | Mortar content (parts by weight) | | | | | | | |
|---|---|---|---|---|---|---|---|---|---|
| | | | | | | High-range | | | |
| | | | Inflating | | | water-reducing | | Gas-forming | |
| Reference | W/C | | agent | | Fine | agent | | agent | |
| example | (%) | Cement | Type | Use amount | aggregate | Type | Use amount | Kind | Use amount |
| 2-1 | 34 | 100 | a | 6 | 100 | A | 0.70 | None | — |
| 2-2 | 34 | 100 | b | 6 | 100 | A | 0.70 | None | — |
| 2-3 | 34 | 100 | a | 6 | 100 | A | 0.70 | α | 0.2 |
| 2-4 | 34 | 100 | b | 6 | 100 | A | 0.70 | α | 0.2 |
| 2-5 | 34 | 100 | a | 6 | 100 | B | 0.90 | α | 0.2 |
| 2-6 | 34 | 100 | a | 6 | 100 | C | 0.14 | α | 0.2 |
| 2-7 | 34 | 100 | a | 6 | 100 | A | 0.70 | β | 0.02 |
| 2-8 | 34 | 100 | a | 6 | 100 | A | 0.70 | γ | 0.2 |

TABLE 3

| | J14 funnel | Bleeding | Expansion | Compressive |
|---|---|---|---|---|
| Reference | flow-time | rate | rate | strength |
| example | (second) | (%) | (%) | (N/mm²) |
| 2-1 | 7.1 | 0 | −0.32 | 70.5 |
| 2-2 | 7.4 | 0 | −0.25 | 67.2 |
| 2-3 | 7.6 | 0 | +0.58 | 68.7 |
| 2-4 | 7.2 | 0 | +0.61 | 68.3 |
| 2-5 | 8.1 | 0 | +0.54 | 69.1 |
| 2-6 | 7.5 | 0 | +0.54 | 68.8 |
| 2-7 | 7.2 | 0 | +0.58 | 69.1 |
| 2-8 | 7.8 | 0 | +0.61 | 67.8 |

As shown in Table 3, reference examples 2-1 and 2-2 exhibited expansion rates of −0.25% to −0.32% indicating shrinkage because they contained no gas-forming agent. On the other hand, reference examples 2-3 to 2-8, in which the mixing ratio of cement and sand was 100:100 and which were added with an inflation agent to compensate for the shrinkage due to hydration and drying of cement after curing, a high-range water-reducing agent to enhance the flowability, and a gas-forming agent of the present invention, exhibited J14 funnel flow-times of 7 to 9 seconds indicating a good flowability as a grout material, and also exhibited expansion rates of +0.54% to +0.61% without bleeding indicating that a shrinkage-free grout material was obtained. Further, the compressive strength measured was of a sufficient level for a grout material.

### Reference Example 3

### PC Grout Material Test

### Material Used:

Cement: Ordinary portland cement, high early strength portland cement, and blast furnace cement B,

Admixture I: Non-expansion type, low viscosity admixture for PC grout (for ordinary cement), “GF-1700” manufactured by NMB Co., LTD,

Admixture II: Non-expansion type, low viscosity admixture for PC grout (for blast furnace cement), “GF-1700(BB)” manufactured by NMB Co., LTD,

Admixture III: Non-expansion type, low viscosity admixture for PC grout (for high early strength cement), “GF-1700 (H) manufactured by NMB Co., LTD,

Gas-forming agent α: “NEOCELLBORN” N#1000SW (main ingredient: 4,4′-oxybis[benzene sulfonyl hydrazide]) manufactured by Eiwa Chemical Ind. Co., LTD,

Gas-forming agent δ: Commercially available Aluminum powder, and

Kneading water: Service water.

Notes: W/C in the table represents (weight of service water/weight of cement)×100(%).

### Test Method:

All the materials were kneaded for 2 to 5 minutes after loading using a hand mixer of a rotational speed of 750 rpm. The resulting grout materials were subjected to the following tests.

i. J14 Funnel Flow-Time

Measurements were conducted according to the Japanese Society of Civil Engineering standard “Test Method of Flowability for Filling Mortar (JSCE-F 531-1999).”

ii. Bleeding Rate and Expansion Rate

Measurements were conducted according to the Japanese Society of Civil Engineering standard “Test method of Bleeding Rate and Expansion Ratio for Filling Mortar (Polyethylene bag method) (JSCE-F 532-1999).” The bleeding rate was measured at the age of 3 hours, and the expansion rate was measured at the age of 1 day. In the Table, negative values of the expansion rate indicate shrinkage and positive values indicate expansion.

iii. Compressive Strength

Compressive strength at the age of 28 days was measured according to the Japanese Society of Civil Engineering standard “Test Method of Compressive Strength for PC grout (JSCE-G 531-1999).”

TABLE 4

| | | | PC grout content (parts by weight) | | | | |
|---|---|---|---|---|---|---|---|
| | | | | | | Gas-forming | |
| | | | | Admixture | | agent | |
| Reference | Kind of | W/C | | | Use | | Use |
| example | Cement | (%) | Cement | Type | amount | Kind | amount |
| 4-1 | Ordinary | 45 | 100 | I | 1.0 | — | — |
| | | | | I | | | |
| 4-2 | Ordinary | 45 | 100 | I | 1.0 | δ | 0.002 |
| 4-3 | Blast | 45 | 100 | II | 1.0 | δ | 0.002 |
| | furnace | | | | | | |
| 4-4 | High | 40 | 100 | III | 1.0 | δ | 0.002 |
| | early | | | | | | |
| | strength | | | | | | |
| 4-5 | Ordinary | 45 | 100 | I | 1.0 | α | 0.3 |
| 4-6 | Blast | 45 | 100 | II | 1.0 | α | 0.5 |
| | furnace | | | | | | |
| 4-7 | High | 40 | 100 | III | 1.0 | α | 0.2 |
| | early | | | | | | |
| | strength | | | | | | |

TABLE 5

| | J14 funnel | Bleeding | Expansion | Compressive |
|---|---|---|---|---|
| Reference | flow-time | rate | rate | strength |
| example | (second) | (%) | (%) | (N/mm²) |
| 4-1 | 8.5 | 0 | −0.37 | 65.1 |
| 4-2 | 8.7 | 0 | +2.12 | 48.5 |
| 4-3 | 8.1 | 0 | +2.45 | 42.2 |
| 4-4 | 8.2 | 0 | +2.09 | 53.7 |
| 4-5 | 8.4 | 0 | +2.27 | 47.3 |
| 4-6 | 8.8 | 0 | +2.25 | 41.5 |
| 4-7 | 8.7 | 0 | +2.63 | 54.6 |

As shown in Table 5, reference example 4-1, which contained no gas-forming agent, exhibited an expansion rate of −0.37% indicating shrinkage. Reference examples 4-2 to 4-4, which contained aluminum powder as the gas-forming agent, exhibited expansion rates of +2.09% to +2.45%. On the other hand, reference examples 4-5 to 4-7, which contained cement, commercially available low viscosity admixture for PC grout (no gas-forming agent), and gas-forming agent of the present invention, exhibited JP funnel flow-times of 8.4 to 8.8 seconds indicating a good flowability as a PC gout material, and also exhibited expansion rates of +2.25 to +2.63 without bleeding meaning that a shrinkage-free PC grout material obtained. Moreover, in the case of reference examples 4-5 to 4-7, the compressive strength was of a sufficient level as a PC grout material, and characteristic properties comparative to those of reference examples 4-2 to 4-4 which contained aluminum powder were obtained.

### Reference Example 4

### Test of High Fluidity Shrinkage-Free Concrete

High fluidity shrinkage-free concrete with compositions shown in Table 6 were prepared by using the following materials, and were tested through a test method shown below. The results are shown in Table 7.

### Material Used:

Cement: Ordinary portland cement,

Fine aggregate: River sand (surface-dry density: 2.60, water absorption: 1.84%, fineness modulus: 2.67),

Coarse aggregate: Crushed stone (MS: 20 mm, surface-dry density: 2.65, water absorption: 0.59%, fineness modulus: 6.74),

High-range water-reducing agent: High-range water-reducing agent “NL-4000” (melamine based) manufactured by NMB Co., LTD,

Shrinkage-free admixture: Admixture for non-bleeding expansion concrete, “Tight-110” (no gas-forming agent) manufactured by NMB Co., LTD,

Gas-forming agent α: “NEOCELLBORN” N#1000SW (main ingredients: 4,4′-oxybis[benzene sulfonyl hydrazide]) manufactured by Eiwa Chemical Ind. Co., LTD, wherein the use amount in the table indicates the proportion with respect to 100 parts by weight of cement,

Gas-forming agent δ: Commercially available Aluminum powder, where the use amount in the table indicates the proportion with respect to 100 parts by weight of cement, and

Kneading water: Service water.

Notes: W/C in the table represents (weight of service water/weight of cement)×100(%).

### Test Method:

All the materials were kneaded for 2 minutes after loading using a pan-type power mixer of a kneading capacity of 50 L. The resulting concrete was subjected to the following tests.

i. Slump Flow

Measurements were made according to JIS A 1105-2001 “Test Method of Slump Flow Test for Concrete.”

ii. Bleeding Rate

Measurements were made according to JIS A 1123-2003 “Test Method of Bleeding Test for Concrete.”

iii. Expansion Rate

Kneaded concrete was poured into a 15 cm diameter by 30 cm length cylindrical flask made of steel, and the top surface of the mixture was flattened by a metal trowel. Thereafter, an acrylic sheet of a 14.5 cm diameter by a 3 mm thickness was placed on the top surface, and the amount of expansion was measured by mounting a dial gauge ( 1/100 mm). The amount of expansion represents a value when expansion was completed. In the Table, negative values of expansion rate indicate shrinkage and positive values indicate expansion.

iv. Compressive Strength

The Compressive strength at the age of 28 days was measured according to JIS A 1108-1999 “Test Method of Compressive Strength for Concrete.”

TABLE 6

| | | Unit quantity (kg/m³) | | | | | |
|---|---|---|---|---|---|---|---|
| | | | | | | | High-range |
| W/C | | | | Fine | Coarse | Shrinkage-free | water-reducing |
| (%) | S/a (%) | Water | Cement | aggregate | aggregate | admixture | agent |
| 51.5 | 53 | 185 | 330 | 880 | 815 | 60 | 3795 ml |

TABLE 7

| | Gas-forming agent | | Slump | Air | | Expansion/ | Compressive |
|---|---|---|---|---|---|---|---|
| Reference | | Use | flow | content | Bleeding | shrinkage | strength |
| example | Type | amount | (cm) | (%) | rate (%) | rate (%) | (N/mm²) |
| 5-1 | δ | 0.007 | 56.0 | 4.0 | 0 | +0.3 | 41.8 |
| 5-2 | α | 0.3 | 58.0 | 3.9 | 0 | +0.3 | 42.5 |
| 5-3 | α | 0.7 | 59.0 | 4.2 | 0 | +1.4 | 39.5 |

As shown in table 7, reference examples 5-2 and 5-3 exhibited slump flow values of 58 to 59 cm indicating a good flowability as a filling or inversely placed concrete. They also exhibited no bleeding and expansion rates of +0.3 to 1.4% indicating no shrinkage, thus proving good concrete. Further, their compressive strength was also of a sufficient level.

### Examples 1 to 10, Comparative Examples 1 to 5

### Grout Material Test III

Grout materials with compositions shown in Table 8 were prepared by using materials shown below, and were tested through a test method shown below. The results are shown in Table 9.

### Used Material:

Cement: Ordinary portland cement,

Fine aggregate: Silica sand of a particle size not greater than 2.5 mm,

High-range water-reducing agent A: “Mighty 100 (naphthalene base)” manufactured by Kao Corporation,

Inflating agent a: “DENKA CSA#20” manufactured by DENKI KAGAKU KOGYO KK,

Inflating agent b: “EXSPAN G” manufactured by TAIHEIYOU CEMENT Corporation,

Gas-forming agent α: “NEOCELLBORN” N#1000SW (main ingredient: 4,4′-oxybis[benzene sulfonyl hydrazide]) manufactured by Eiwa Chemical Ind. Co., LTD,

Gas-forming agent δ: Commercially available aluminum powder,

Nitrite X: Commercially available Lithium nitrite water solution (use amount in the table indicates the amount of solid part),

Nitrite Y: Commercially available calcium nitrite water solution (use amount in the table indicates the amount of solid part),

Nitrite Z: Commercially available sodium nitrite water solution (use amount in the table indicates the amount of solid part), and

Kneading water: Service water.

Notes: W/C in the table represents (weight of service water/weight of cement)×100(%)

### Test Method:

All the materials were kneaded for 2 minutes after loading using a hand mixer of a rotational speed of 750 rpm. The resulting grout materials were subjected to the following tests.

i. J14 Funnel Flow-Time

Measurements were conducted according to the Japanese Society of Civil Engineering standard “Method of Flowability Test for Filling Mortar (JSCE-F 541-1999).”

ii. Bleeding Rate and Expansion Rate

Measurements were conducted according to the Japanese Society of Civil Engineering Standard “Test Method of Bleeding Rate and Expansion Rate for Filling Mortar (container method) (JSCE-F 542-1999).” The bleeding rate was measured at the age of 3 hours, and the expansion rate was measured at the age of 1 day. In the Table, negative values of the expansion rate indicate shrinkage and positive values indicate expansion.

iii. Compressive Strength

Compressive strength at the age of 28 days was measured according to the Japanese Society of Civil Engineering Standard “Test Method of Compressive Strength for Filling Mortar (JSCE-G 541-1999).”

TABLE 8

| | | Mortar content (parts by weight) | | | | | | | | | |
|---|---|---|---|---|---|---|---|---|---|---|---|
| | | | | | | High-range | | | | | |
| | | | Inflating | | | water-reducing | | | | | |
| | | | agent | | | agent | | Gas-forming agent | | Nitrite | |
| | W/C | | | Use | Fine | | Use | | Use | | Use |
| | (%) | Cement | Type | amount | aggregate | Type | amount | Kind | amount | Type | amount |
| Comprehensive | 34 | 100 | a | 6 | 100 | A | 0.70 | None | — | None | |
| example 1 | | | | | | | | | | | |
| Comprehensive | 34 | 100 | a | 6 | 100 | A | 0.70 | δ | 0.0015 | None | — |
| example 2 | | | | | | | | | | | |
| Comprehensive | 34 | 100 | a | 6 | 100 | A | 0.70 | δ | 0.0015 | X | 4.0 |
| example 3 | | | | | | | | | | | |
| Comprehensive | 34 | 100 | a | 6 | 200 | A | 0.70 | δ | 0.002 | None | — |
| example 4 | | | | | | | | | | | |
| Comprehensive | 34 | 100 | a | 6 | 200 | A | 0.70 | δ | 0.002 | X | 4.0 |
| example 5 | | | | | | | | | | | |
| Example 1 | 34 | 100 | a | 6 | 100 | A | 0.70 | α | 0.2 | None | — |
| Example 2 | 34 | 100 | a | 6 | 100 | A | 0.70 | α | 0.2 | X | 0.5 |
| Example 3 | 34 | 100 | b | 6 | 100 | A | 0.70 | α | 0.2 | X | 2.0 |
| Example 4 | 34 | 100 | a | 6 | 100 | A | 0.70 | α | 0.2 | X | 4.0 |
| Example 5 | 34 | 100 | a | 6 | 100 | A | 0.70 | α | 0.2 | X | 6.0 |
| Example 6 | 43 | 100 | a | 6 | 200 | A | 0.90 | α | 0.25 | None | — |
| Example 7 | 43 | 100 | a | 6 | 200 | A | 0.90 | α | 0.25 | X | 5.0 |
| Example 8 | 43 | 100 | a | 6 | 200 | A | 0.90 | α | 0.25 | X | 10.0 |
| Example 9 | 34 | 100 | a | 6 | 100 | A | 0.70 | α | 0.2 | Y | 4.0 |
| Example 10 | 34 | 100 | a | 6 | 100 | A | 0.70 | α | 0.2 | Z | 4.0 |

TABLE 9

| | J14 funnel | Bleeding | Expansion | Compressive |
|---|---|---|---|---|
| | flow-time | rate | rate | strength |
| | (second) | (%) | (%) | (N/mm²) |
| Comprehensive | 7.1 | 0 | −0.34 | 70.5 |
| example 1 | | | | |
| Comprehensive | 7.3 | 0 | +0.47 | 68.4 |
| example 2 | | | | |
| Comprehensive | 7.6 | 0 | −0.23 | 71.5 |
| example 3 | | | | |
| Comprehensive | 8.7 | 0 | +0.87 | 53.4 |
| example 4 | | | | |
| Comprehensive | 8.4 | 0 | −0.28 | 55.1 |
| example 5 | | | | |
| Example 1 | 7.1 | 0 | +0.45 | 67.2 |
| Example 2 | 7.6 | 0 | +0.52 | 68.7 |
| Example 3 | 7.2 | 0 | +0.55 | 68.3 |
| Example 4 | 7.4 | 0 | +0.51 | 69.1 |
| Example 5 | 7.5 | 0 | +0.54 | 60.4 |
| Example 6 | 8.5 | 0 | +0.79 | 53.3 |
| Example 7 | 8.9 | 0 | +0.82 | 54.4 |
| Example 8 | 9.1 | 0 | +0.86 | 47.6 |
| Example 9 | 8.9 | 0 | +0.59 | 69.1 |
| Example 10 | 8.5 | 0 | +0.57 | 69.7 |

The examples 1 to 10, in which as shown in Table 8 the ratio of cement and sand was 100:100 or 100:200, and which was added with an inflating agent for compensating for the shrinkage due to hydration and drying of cement after curing, a high-range water-reducing agent for enhancing the flowability, the inflating agent of the present invention, and further nitrite, had J14 funnel flow-times of 7 to 9 seconds indicating a good flowability as a grout material, exhibited no bleeding, and expansion rates of +0.45% to +0.86% meaning that a shrinkage free grout material was obtained. Moreover, their compressive strength was of a sufficient level for a grout material. On the other hand, comparative examples 3 and 5, which had the same composition with the examples 1 to 10 but contained conventionally utilized aluminum powder as the gas-forming agent, exhibited expansion rates of −0.23% and −0.28% indicating shrinkage. Comparative examples 2 and 4, which contained aluminum powder as the gas-forming agent, exhibited expansion rates of +0.47 and +0.87 indicating expansion because they did not contain nitrite.

### INDUSTRIAL APPLICABILITY

The gas-forming agent for cement composition according to the present invention can make the cement composition containing nitrite to expand thereby preventing the shrinkage of the cement composition, and therefore can be suitably used for cement compositions such as grout materials containing nitrite, PC grout materials, mortar materials, concrete materials.

1. A gas-forming agent for a cement composition containing nitrite, said gas-forming agent comprising a substance which produces nitrogen gas through a reaction in said cement composition.

2. The gas-forming agent according to claim 1, wherein said substance which produces nitrogen gas through a reaction in the cement composition includes at least one compound selected from the group consisting of sulfonyl hydrazide compounds azo compounds, and nitroso compounds.

3. A cement composition containing nitrite, comprising the gas-forming agent according to claim 1.

4. The cement composition according to claim 3, wherein said cement composition is used for a grout material, a PC grout material, mortar material, or a concrete material.

5. The cement composition according to claim 3, further comprising a water-reducing agent.

6. The cement composition according to claim 3, further comprising an inflating agent.

7. A method for preventing shrinkage of a cement composition containing nitrite, said method comprising mixing the gas-forming agent according to claim 1 into the cement composition.

8. The method for preventing shrinkage according to claim 7, wherein the cement composition is a grout material, a PC grout material, a mortar material, or a concrete material.

9. The method for preventing shrinkage according to claim 7, said method comprising further adding a water-reducing agent.

10. The method for preventing shrinkage according to claim 7, said method comprising compensating for the shrinkage of the cement composition before curing by means of the gas-forming agent, and compensating for the shrinkage of the cement composition after curing by means of an inflating agent.

11. (canceled)

12. (canceled)

13. (canceled)

14. (canceled)

15. The cement composition according to claim 3, wherein the gas forming agent comprises at least one of p-toluenesulfonyl hydrazide, p,p′-oxybis(benzene sulfonyl hydrazide), and 4,4′-oxybis(benzene sulfonyl hydrazide).

16. The cement composition according to claim 3, wherein the gas forming agent comprises at least one of azodicarbonamide, and azobisisobutyronirile.

17. The cement composition according to claim 3, herein the gas forming agent comprises N,N′-dinitrosopentamethylenetetramine.
